(19) United States
(12) Patent Application Publication
(10) Pub. No.: US 2009/0064506 A1
(43) Pub. Date: Mar. 12, 2009

(54) Better way (A. B. W) cactus cleaner

(76) Inventor: Henry Ramos, Tulare, CA (US)

Correspondence Address: Henry Ramos, 233 No. A., Tulare, CA, 93274, US

(21) Appl. No.: 11/649,114

(22) Filed: Sep. 11, 2007

(51) Int. Cl. B26B 3/00

(52) U.S. Cl. 30/314

(57) ABSTRACT

The cactus cleaner is a lightweight one piece tool designed with two sharpened blades for removing thorns from cactus in both directions, and a tubular handle for usage with either hand. The front of the cleaner is also tooled for removing thorns with a scooping manner.

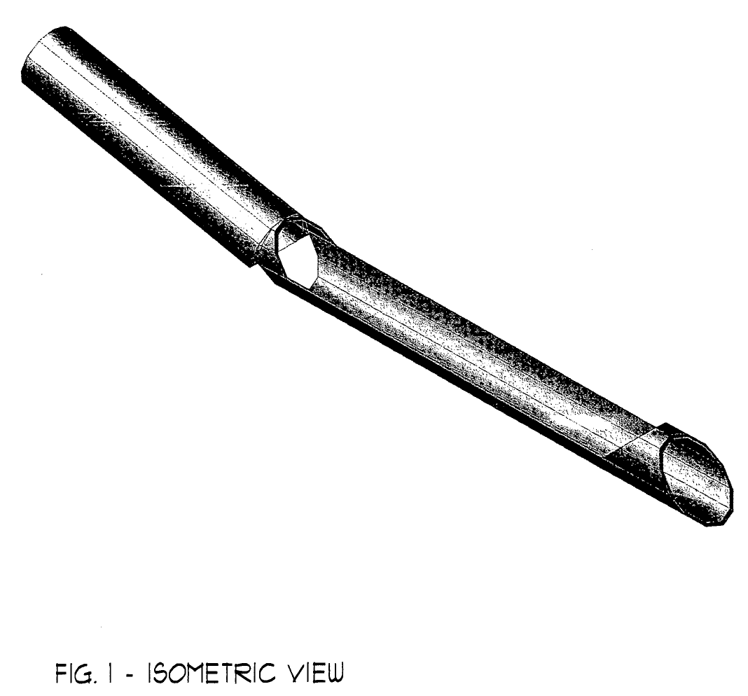

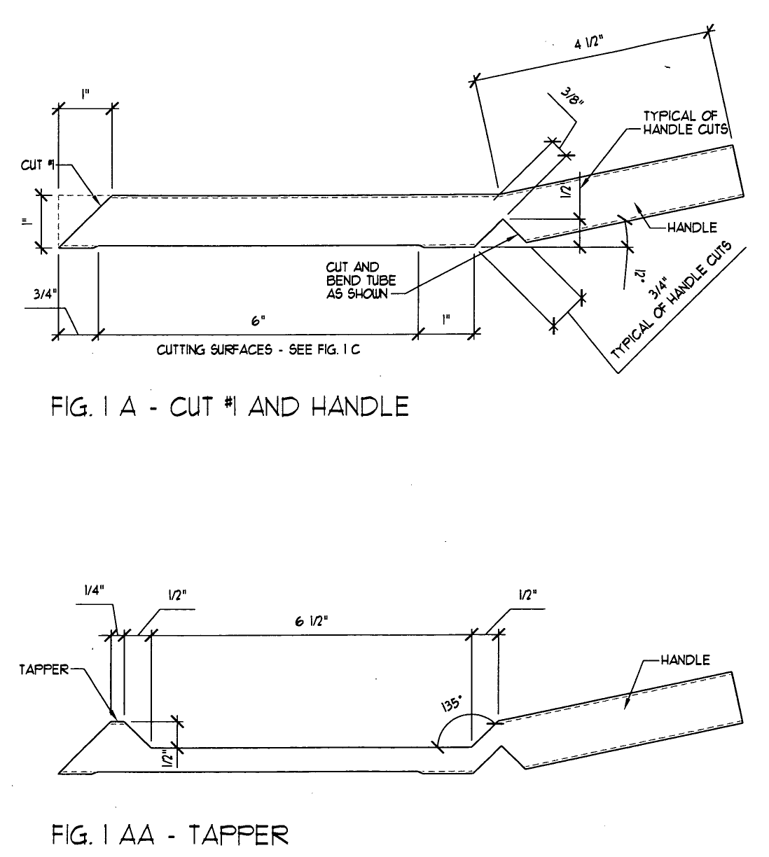

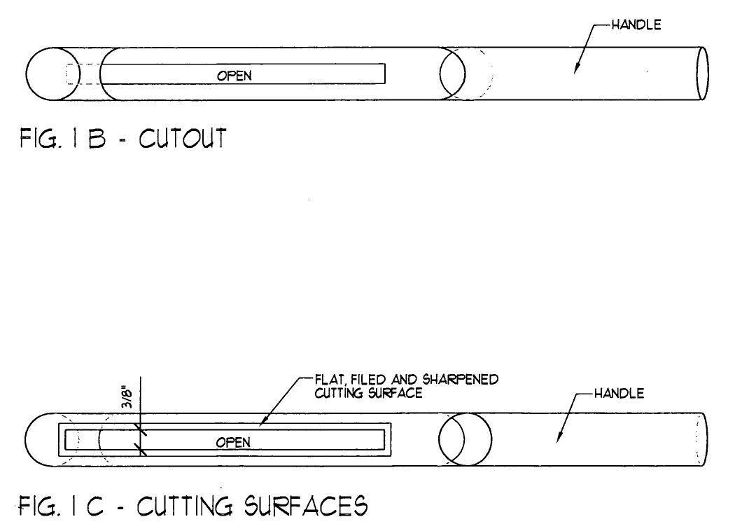

FIG. 1A shows the tip of the invention with the 1″×45 degree cutout.

FIG. 1A also shows the length of the 6″ cutting surfaces.

FIG. 1A also shows the ¾″ cutout and 12 degree bend for the handle.

The 4½″ length of the handle is also shown in FIG. 1A.

FIG. 1AA depicts the ¼″×½″ area of the frontal tapper dimension.

FIG. 1AA this view also shows the 6½″ length of the upper cutout and the left and right 45 degree cuts to complete the ½″ depth of cutout.

FIG. 1B this top cutout view shows the oval frontal tip as shown in FIG. 1A.

FIG. 1B also depicts the openness of the top cutout shown in FIG. 1AA.

FIG. 1C shows the cutting surface that runs parallel with the ⅜″ width of the blades and the area where the blades are sharpened.

What is claimed is:

1. A cactus removing tool all inclusive; having two parallel machined sharpened blades. Said blades of tool used in horizontal motion over cactus, said tool having a sharpened oval tip to enable user to remove thorns from uneven cactus: Said tool having a handle to manipulate tool with a back and forth motion on cactus surface, said tool having sharpened oval tip, on opposite side of said tip used for cleaning accumulated thorns of said cleaner by gently tapping of said tool on cutting board.

2. A cactus cleaner as claimed in claim 1, said tool comprising of two sharpened blades.

3. A cactus cleaner as claimed in claim 1, said tool comprising of sharpened oval tip.

4. A cactus cleaner as claimed in claim 1, said tool comprising a handle for grasping tool.

5. A cactus cleaner as claimed in claim 3, said tool comprising of design area for thorn removal.
